(19) United States
(12) Patent Application Publication
(10) Pub. No.: US 2012/0244396 A1
(43) Pub. Date: Sep. 27, 2012

(54) ELECTROCHEMICAL ENERGY STORE DEVICE COMPRISING A CONTAINER

(75) Inventors: Tim Schaefer, Niedersachswerfen (DE); Andreas Gutsch, Luedinghausen (DE)

(73) Assignee: LI-TEC BATTERY GMBH, Kamenz (DE)

(21) Appl. No.: 13/496,125

(22) PCT Filed: Aug. 27, 2010
(86) PCT No.: PCT/EP10/05288

§ 371 Date: May 30, 2012

(30) Foreign Application Priority Data
Sep. 14, 2009 (DE) 10 2009 041 508.4

(51) Int. Cl. H01M 10/34; H01M 2/16; H01M 4/485; H01M 2/02

(52) U.S. Cl. 429/59; 429/57; 29/623.1

(57) ABSTRACT

In an electrochemical energy store device, the electrochemically active components (11, 13, 21, 23, 31, 33), or additional components (12, 22, 32), are designed and/or arranged in a hermetically sealed container such that they inhibit the process of a chemical reaction of the electrochemically active components of the energy store device as soon as positive pressure builds, or could build, inside the container as a result of said chemical reaction. Preferably, the flow (14, 34, 35) of a movable component into the area of a chemical reaction, in which said movable component participates as a reactant, is inhibited or suppressed, at least locally, as soon as positive pressure build, or could build, inside the container as a result of said chemical reaction.

The present invention relates to an electrochemical energy store device, in particular an electrochemical energy store device operating on the basis of lithium ions.

For the commercial application of electrochemical energy store devices, in addition to other factors the simplest possible, least expensive design and the maximum possible safety in handling and using such energy store devices are decisive factors. The main safety risk in connection with electrochemical energy store devices occurs when the galvanic cells contained therein overheat due to high production of heat, or when such overheating threatens to occur. A high production of heat can be the result of, for example, internal or external short-circuits, reactions due to overcharging, when overloading occurs, the effect of external heat sources, charging at high current, charging with a high charging factor, beginning the charging process at an already high temperature and with poor cooling.

The temperature increase causes heating of the electrolyte inside a cell, until in some cases it ultimately evaporates. A resulting accumulation of electrolyte vapour inside a gas-tight sealed cell frequently leads to an increasing internal pressure. If the internal pressure exceeds a threshold, an explosion can occur in the cell, wherein materials contained in the cell that are hazardous to humans can escape, or a fire can be ignited.

Safety devices for electrochemical energy store devices are known, which counteract excessive gas accumulation inside a gas-tight sealed cell and/or a cell stack, by allowing resulting gases to escape if the internal pressure of the cell exceeds a pre-defined threshold value. Some of the safety devices known from the prior art comprise valves which facilitate pressure equalisation. Such a proposal is found for example in patent document U.S. Pat. No. 5,523,178, in which a valve for a galvanic cell is described. The implementation of such valves however is frequently fraught with difficulties. Due to the high complexity of the valve design, production complexity increases, and with it also the costs involved in manufacturing a cell. Less complex valves have the disadvantage that they only open at high pressure, or only in a narrow pressure range.

A further safety device known from patent application US 2006/001 91 50 A1 provides that the housing of a cell or a cell stack is fitted with predetermined breaking points, which yield at a predetermined internal pressure in order to offer a means of release for any vapour produced. Some of such predetermined breaking points are configured such that when they break apart they interrupt the electrical conduction between the similarly polarised electrodes of a cell and the corresponding current collectors of the module.

From DE 10 2008 006 026 A1 a safety device for electrical devices operating on galvanic principles is known, having a controlled transfer of such devices from a first operating state into a second operating state, in which the functionality, and in particular the reaction potential, of the device is reduced or completely disabled.

On account of the various disadvantages or limitations associated with such types of safety devices for galvanic cells, the problem addressed by the present invention is to specify a hermetically sealable electrochemical energy store device which can operate successfully without such safety devices as, for example, valves, predetermined breaking points or rupture discs.

This problem is solved by an electrochemical energy store device or by a method for producing an electrochemical energy store device according to one of the independent claims.

According to the invention an electrochemical energy store device is provided, having electrochemically active components which are arranged inside a container. These electrochemically active components or additional components arranged in the container are configured or arranged such that they inhibit the process of at least one chemical reaction of at least one electrochemically active component of the energy store as soon as positive pressure builds, or could build, inside the container as a result of said chemical reaction.

In connection with the present invention, an electrochemical energy store device is understood to mean any device that can convert chemical energies directly into electrical energies and supply them to an application. The term thus includes in particular galvanic cells or assemblies of a plurality of galvanic cells, but also for example fuel cells and other devices for converting chemical energy into electrical energy. The electrochemical store devices in the context of the present invention include in particular rechargeable electrochemical energy store devices, to which electrical energy can be supplied which is then stored in the electrochemical energy store device as chemical energy. Important examples of such electrochemical energy store devices are rechargeable galvanic cells or assemblies of a plurality of such cells.

In connection with the present invention, a container of an electrochemical energy store device is to be understood as any type of container, housing or packaging which is suitable for protecting the electrochemically active components and other components which the electrochemically active components based on their construction or on their effect against external influences. In particular, these can be rigid or flexible housings or foil packages, in particular multi-layer foil packages, into which for example the electrode stacks and the separators isolating the electrodes are packed, together with the electrolyte and the electrical collectors of the galvanic cell.

In connection with the present invention, an (electrochemically) active component of an electrochemical energy store device is to be understood as any component of such an energy store device that in any way participates in the electrochemical processes which underlie the storage of energy in the energy store device, or supports these processes. This term is to be understood therefore as meaning in particular the electrodes and the so-called electrolyte. Not included in the electrochemically active components are the container, the housing or the packaging of a galvanic cell. Examples of supporting components are the separator or the current collectors, which are often (and not always completely consistently) not counted as part of the (electrochemically) active components of an electrochemical energy store device.

In connection with the present invention, additional components of an electrochemical energy store device are to be understood as meaning any component arranged in the housing, in the container or in the packaging of the energy store device, which is not to be counted as being part of the electrochemically active components. Examples of these are in particular, as long as these are not counted as part of the active components, the separators, which serve to prevent a short-circuit occurring between the electrodes. Whether it is correct to include a separator in the active components may, for example, also depend on whether this separator contains a material which is affected by an (electro-)chemical reaction and/or affects such a reaction.

In connection with the present invention, a chemical reaction (of at least a part) of the (electrochemically) active components of an electrochemical energy store device is understood to mean any chemical reaction in which the electrochemically active components of an electrochemical energy store device can participate as a co-reactant. These therefore include in particular the so-called cell reaction and also those (electrochemical) reactions which proceed at the electrodes, and which together produce the so-called cell reaction. These chemical reactions are in most cases associated with the charge transfer of ions. The energy changes associated with such reactions manifest themselves by an emission of heat in the case of exothermic reactions, and by an absorption of heat in the case of endothermic reactions.

The inhibition of such a chemical reaction is to be understood to mean any measure by which the reaction speed of this chemical reaction is reduced, or by which the equilibrium point of this chemical reaction is moved such that the reaction is wholly or very nearly brought to a halt. Further example of inhibition of a chemical reaction are the removal of starting materials of this reaction or the shielding of a starting material of this chemical reaction from other reactants, for example by a chemically inert coating over an electrode.

In connection with the present invention, a positive pressure is to be understood to mean a pressure which is greater than the pressure outside the container of the electrochemical energy store device, where this increased pressure exceeds a possibly desired, constructionally determined increased pressure in the interior of the cell.

Advantageous extensions and preferred exemplary embodiments of the invention form the subject matter of dependent claims.

The electrochemically active or other components of this electrochemical energy store device preferably comprise a mobile component, the flow of which into the region of a chemical reaction, in which this mobile component is involved as a reactant, is at least locally inhibited or suppressed as soon as positive pressure builds, or could build, inside the container as a result of said chemical reaction. The result of this measure is that the reactant which is required for the further process of the chemical reaction and which is consumed by the chemical reaction, cannot flow back into the reaction region, which means that the chemical reaction is particularly effectively inhibited or even terminated.

In connection with the present invention, a mobile component of an electrochemical energy store device is to be understood to mean a component of this electrochemical energy store device which by its nature is capable of material transport, i.e. in particular is capable of a flow or diffusion process. Important examples of such mobile components are fluids, i.e. in particular gels, liquids or gases. A particularly important example of a moveable component of an electrochemical energy store device is represented by the electrolyte, but also any possible individual chemical component of such an electrolyte, for example ions, or ions bound to a solvent, or a solvent or mixtures of such components.

In connection with the present invention, the flow of a mobile component of an electrochemical energy store device is to be understood to mean any type of material transport of a material of a mobile component of the electrochemical energy store device, i.e. in particular a transport by flow or a transport by diffusion. This can involve mechanically induced or thermally induced flows. The diffusion can of course also be regarded as microscopic flow, with which a so-called diffusion current is associated. This can be caused by a concentration gradient or by other thermodynamic forces, such as for example potential differences.

In connection with the present invention, the region of a chemical reaction in an electrochemical energy store device is to be understood to mean a spatial, not necessarily contiguous region inside the electrochemical energy store device, inside which said chemical reaction proceeds and outside which said chemical reaction is practically absent or only proceeds on a negligible or in a constructionally defined, desired scale. In the case of chemical reactions which are in principle desired, in which it is only the exceeding of a particular reaction speed or a particular scale of the reaction which is not desired, the region of said chemical reaction is to be understood to mean a spatial region inside the energy store device inside which this chemical reaction proceeds in an undesired manner, and outside which the chemical reaction does not proceed in an undesired manner but if it does proceed, it does so in the desired manner.

In connection with the present invention, the (at least local) inhibition or suppression of the flow of a mobile component of an electrochemical energy store device is to be understood to mean any measure or any process by which the flow of said mobile component is at least locally, i.e., in a spatially restricted or bounded manner, inhibited or suppressed. Examples of such measures are the closing off, including the partial closing off, of flow channels or diffusion channels, or also changes in the condition of the assembly or in the flow capability of a mobile component, as long as these changes are designed for preventing or suppressing the flow of this mobile component.

In chemistry, an educt is the term used to refer to a material or a substance which is or can be a starting material of a chemical reaction. Such materials or substances are also referred to as reactants, reactands or simply as starting materials.

A further preferred exemplary embodiment of the invention provides an electrochemical energy store device in which an at least local change in the temperature, associated with exceeding or undershooting a temperature threshold inside the container, causes the inhibition or suppression of said chemical reaction. This results in the advantage that in particular in the case of exothermic chemical reactions a temperature change often occurs more rapidly than a pressure increase, induced for example by out-gassing of a reaction product, whereby the inhibition or suppression of said chemical reaction according to the invention can be induced more rapidly.

An example of this can be illustrated by such reactions in which a gaseous reaction product is formed, or in which an initially liquid reaction product is formed, which under the influence of the increase in temperature associated with an exothermic reaction with too little cooling applied, transitions into the gas phase. In such cases a temperature increase will frequently occur first, which will not lead an increased formation or to an increased thermal expansion of the gaseous reaction products until later stages of the reaction.

A particularly preferred exemplary embodiment of the invention therefore provides for the production or thermal expansion of gaseous reaction products, in particular of exothermic chemical reactions, to be counteracted by an effective cooling of the inside of the electrochemical energy store device. Such a cooling can be implemented in different ways, the expedient selection of which depends on the remaining circumstances of the design of the electrochemical energy store device and its application environment.

A further preferred exemplary embodiment of the invention provides that the inhibition or suppression of this chemical reaction is at least partially reversible. By this means it can be obtained that the inhibition or suppression of said chemical reaction according to the invention need not lead to the relevant parts of the electrochemical energy store device being permanently switched off, but that under suitable circumstances a limited reduction in the power of the electrochemical energy store device can take the place of a permanent shut-down, which under further suitable circumstances can be restricted not only quantitatively but also temporally.

A further preferred exemplary embodiment of the invention provides that the inhibition of the chemical reaction is effected by a coating of the electrodes which is preferably inert or self-inertising, i.e. one which chemically converts itself into an inert coating, said coating being preferably at least locally chemically changed, preferably inertised, by said chemical reaction.

A further preferred exemplary embodiment of the invention provides that the inhibition of the chemical reaction is effected by a separator layer separating the electrodes, which is designed such that a flow of at least one reactant of said chemical reaction along said layer is at least locally inhibited or suppressed, as soon as positive pressure builds, or could build, inside the container as a result of said chemical reaction.

A further preferred exemplary embodiment of the invention provides that the inhibition of the chemical reaction is effected by a separator layer separating the electrodes which is formed of a porous inorganic material.

A further preferred exemplary embodiment of the invention provides that the inhibition of the chemical reaction is effected by a separator layer made of a porous inorganic material separating the electrodes, which comprises particles which melt on reaching or exceeding a temperature threshold and at least locally reduce in size or close the pores of the separator layer.

A further preferred exemplary embodiment of the invention provides that the particles consist of a material which is selected from a group of materials comprising polymers or compounds of polymers, waxes and compounds of these materials.

A further preferred exemplary embodiment of the invention provides that the separator layer is configured in such a manner that, due to a capillary action, its pores become filled with the mobile component which is involved as a reactant in the chemical reaction, so that only a relatively small part of the total quantity of the mobile component present in the energy store device is situated outside the pores of the separator layer.

Below, the invention will be described in greater detail based on preferred exemplary embodiments and with the aid of the Figures. They show:

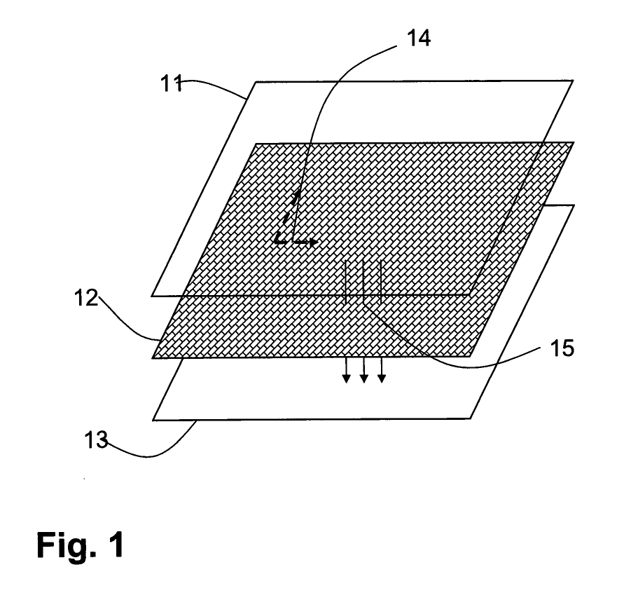

FIG. 1 an arrangement of two electrodes and one separator with material transports indicated by arrows, according to an exemplary embodiment of the present invention;

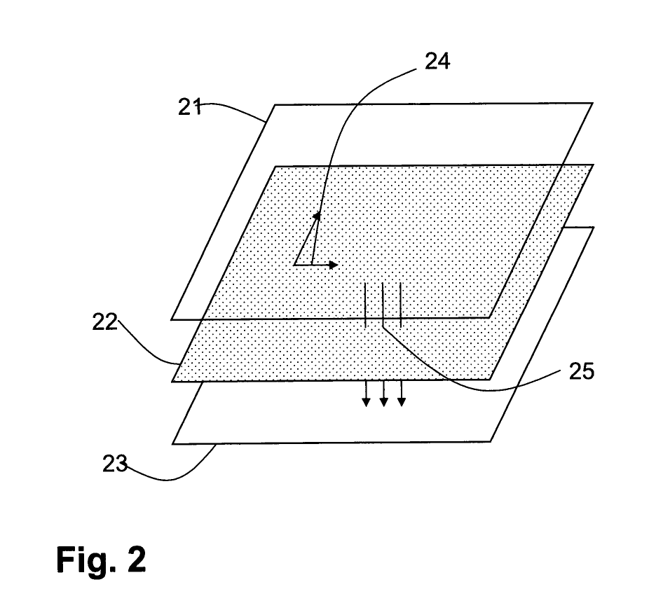

FIG. 2 an arrangement of two electrodes and one separator with material transports indicated by arrows, according to a second exemplary embodiment of the present invention; and

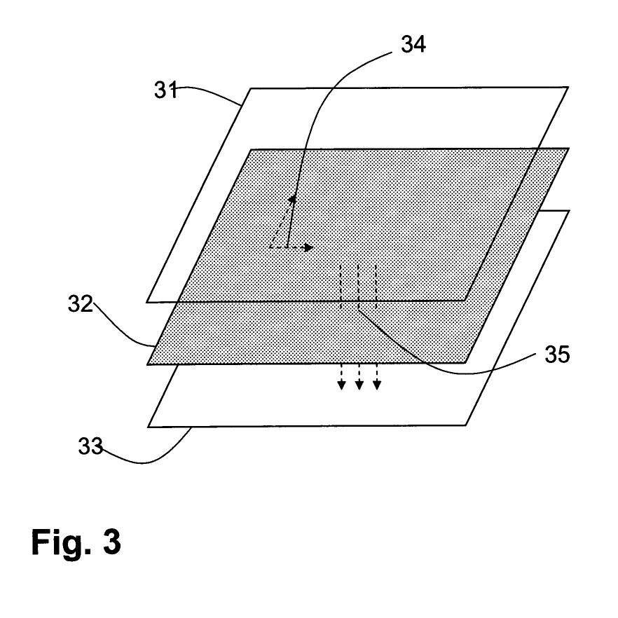

FIG. 3 an arrangement of two electrodes and one separator with material transports indicated by arrows, according to a third exemplary embodiment of the present invention.

The invention provides an electrochemical energy store device having electrochemically active components 11, 13, 21, 23, 31, 33, arranged inside a container. These electrochemically active components, or additional components 12, 22, 32 arranged in the container, are designed or configured such that they inhibit at least one chemical reaction of at least a part of the electrochemically active components of the energy store device as soon as positive pressure builds, or could build, inside the container as a result of said chemical reaction.

A desired consequence of this configuration of the electrochemical energy store device according to the invention is that the container of said electrochemical energy store device can be hermetically sealed or configured, and that in particular, safety devices such as over-pressure valves, predetermined breaking points or rupture discs in the container, in the housing or in the packaging of said electrochemical energy store device can be dispensed with. This is associated with important design advantages which relate not only to the simplification of the production of the energy store device, but also to its safety during application.

A pressure increase inside the container of an electrochemical energy store device is mainly to be expected when a chemical reaction is proceeding in said container, the reaction products of which include gaseous materials, or liquids which greatly expand when heat is generated. According to a preferred embodiment of the present invention this is obtained by the fact that a reactant (starting material) of this chemical reaction which could lead to the build-up of positive pressure is prevented from flowing back into the region of the chemical reaction. In many cases it is sufficient in this regard if the flow of this reactant is at least locally inhibited or completely suppressed, as soon as positive pressure builds, or could build, inside the container as a result of this chemical reaction.

An important example of such a reactant, the flow of which into the region of a chemical reaction could be at least locally inhibited or suppressed, is the electrolyte, which in many galvanic cell types is present in liquid form. Since the chemical reaction which could lead to the build-up of positive pressure consumes the starting material, the replenishment thereof, in particular by additional inflow into the reaction region, is a necessary prerequisite for the maintenance of the chemical reaction. The inhibition or suppression of further inflow or further replenishment of this starting material into the reaction region is therefore a suitable measure by which to inhibit, at least in a spatially bounded manner, the process of the chemical reaction or the undesired scale or undesired speed thereof, and thus to delay or stop the undesired pressure increase inside the container.

In many cases, chemical reactions are associated with a temperature increase inside the electrochemical energy store device, even before the pressure inside the container noticeably increases. This will be the case for example when an undesired chemical reaction proceeds, or a desired chemical reaction proceeds on an undesired scale in a highly spatially localised manner, so that at first only a local temperature increase occurs, which is frequently initially associated with small instances of outgassing or evaporation, but which with continuing propagation of the temperature increase, for example due to heat conduction, can only after a noticeable delay lead to an escalation in the outgassing or evaporation, and thereby possibly to a considerable pressure increase.

In such cases an additional embodiment of the invention is particularly advantageous, in which at least a local change in the temperature, associated with an overshoot or undershoot of a temperature threshold inside the container, already causes the inhibition or suppression of said chemical reaction. In this manner a pressure increase can be prevented at an early stage. Such exemplary embodiments of the invention can be advantageously implemented by, for example, a reactant or a catalyst of the chemical reaction which causes the temperature increase transitioning from the solid into the liquid or the gaseous phase, whereby the geometrical arrangement of the reaction partners in the electrochemical energy store device can change such that the chemical reaction causing the temperature increase is suppressed or at least inhibited. Another possibility for implementing this exemplary embodiment consists in blocking or shrinking the pores of a porous structure by melting a substance, whereby the flow of a reactant of the chemical reaction is inhibited or suppressed.

In some cases particular advantages accrue when the inhibition or suppression of this chemical reaction is at least partially reversible. If this is in fact the case, then the power reductions which are in many cases associated with the suppression or inhibition of the chemical reaction can be at least partially reversed once the threat to the electrochemical energy store device has been eliminated.

An example of such a mechanism is represented by a reaction which produces a gaseous material or causes a previously non-gaseous material to transition to the gas phase under the generation of heat, thus leading to a pressure increase, but which after the reaction heat has dissipated, returns to the liquid state. If the energy store device is designed such that the gaseous material escapes from the reaction region and a reactant is therefore removed from or forced out of the reaction, or its availability is reduced by other means, then as a consequence of the escape of the gaseous reaction partner or of the reduced availability of a reactant, the reaction will come to a halt. As a result, the heat generated will subside and the cell will cool down, in particular when it is cooled by additional measures. As a result, the gaseous reaction partner can again condense into the liquid phase, flow back into the reaction region, and the cell can resume its normal operation.

An additional preferred embodiment of the present invention provides that the inhibition of the chemical reaction is effected by a coating of the electrodes, which are at least locally chemically changed by the chemical reaction. It is thus possible, for example, to coat an electrode, preferably the cathode, with a ceramic separator such as for example Separion, whereby an inhibition of the chemical reaction can be effected. Other possible coatings of the electrodes are passivising coatings, for example of oxides of the metals used in the electrodes.

An additional preferred embodiment of the present invention provides that the inhibition of the chemical reaction is effected by a separator layer separating the electrodes, which is designed such that a flow of at least one reactant of said chemical reaction along said layer is at least locally inhibited or suppressed, as soon as positive pressure builds, or could build, inside the container as a result of said chemical reaction. This exemplary embodiment of the invention also comprises embodiments in which a flow of said reactant of the chemical reaction along said separator layer is continuously inhibited or suppressed, for example because the separator layer comprises channels oriented perpendicular to the layer, in which said reactant can freely move, but wherein the reactant cannot freely move between the channels.

Preferably at least one electrode of the electrochemical energy store device, particularly preferably at least one cathode, comprises a compound with the formula LiMPO4,wherein M is at least one transition metal cation from the first row of the periodic table of the elements. The transition metal cation is preferably chosen from the group consisting of Mn, Fe, Ni and Ti, or a combination of these elements. The compound preferably has an olivine structure, preferably higher-order olivine.

In a further embodiment at least one electrode of the electrochemical energy store device, particularly preferably at least one cathode, preferably comprises a lithium manganate, preferably LiMn204 of the spinell type, a lithium cobaltate, preferably LiCo02, or a lithium nickelate, preferably LiNi02, or a mixture of two or three of these oxides, or a lithium compound oxide which contains manganese, cobalt and nickel.

FIG. 1 shows a schematic view of an embodiment of the invention in which two electrodes 11 and 13 are separated by a separator layer 12, which does allow a material transport 15 in the direction perpendicular to the separator layer but which inhibits or suppresses a material transport 14 tangential to the separator layer, which in this Figure is indicated by dashed arrows 14.

Such separator materials can also consist, for example, of porous inorganic materials the composition of which is such that material transport can take place through the separator perpendicular to the separator layer, whereas material transport parallel to the separator layer is inhibited or even suppressed.

Particularly preferable in this case are separator materials consisting of a porous inorganic material, which is permeated with particles or comprises such particles at least on its surface, which melt and at least locally shrink or close up the pores of the separator layer on reaching or exceeding a temperature threshold. Such particles can preferably consists of a material which is selected from a group of materials comprising polymers or compounds of polymers, waxes or mixtures of these materials.

FIG. 2 shows a schematic view of an embodiment of the invention in which two electrodes 21 and 23 are separated by a separator layer 22 which allows a material transport 25 in the direction perpendicular to the separator layer and allows a material transport 24 tangential to the separator layer 22, because the particles of the separator 22 that melt above a temperature threshold have not yet melted.

FIG. 3 shows a schematic view of an embodiment of the invention in which two electrodes 31 and 33 are separated by a separator layer 32, which allows a material transport 15 in the direction perpendicular to the separator layer and inhibits or suppresses a material transport 14 tangential to the separator layer 32, which in this Figure is indicated by dashed arrows 14, because the particles of the separator 22 that melt above a temperature threshold have already melted.

Particularly preferred is an embodiment of the invention in which the separator layer is configured such that its pores, due to a capillary action, its pores become filled with the mobile component which is involved as a reactant in the chemical reaction, so that only a relatively small part of the total quantity of the mobile component present in the energy store device is situated outside the pores of the separator layer. In this context the electrolyte or one of its chemical components or a mixture of such components is a particularly preferred reactant, which according to a particularly preferred exemplary embodiment of the invention as far as possible wets or permeates the entire porous separator layer, but which outside the separator layer can either not be found at all, or only in negligible or relatively low quantities. Such an arrangement can be obtained during the production of the electrochemical energy store device by the porous separator being soaked with the electrolyte or another reactant of a suitably chosen chemical reaction, so that said reactant is subsequently only to be found in the separator.

If a pressure increase, possibly initially only locally, then occurs due to a chemical reaction, due to formation of a gas bubble or a local heating, this reactant cannot then be replenished by flowing back from other regions into the reaction region. To the extent that, or for as long as, it can still flow back, the availability of this reactant at other places is correspondingly reduced. The reaction ultimately comes to a halt or at least remains limited to a preferably small region.

According to the invention, a separator is preferably used which does not conduct electrons or does so only weakly, and which consists of an at least partially material-permeable substrate. The substrate is preferably coated on at least one side with an inorganic material. As the at least partially material-permeable substrate, an organic material, which is preferably implemented as a non-woven fabric, is preferably used. The organic material, which preferably comprises a polymer and particularly preferably a polyethylene terephthalate (PET), is coated with an inorganic, preferably ion-conducting material, which is further preferably ion-conducting in a temperature range of −40° C. to 200° C. The ion-conducting material preferably comprises at least one compound from the group oxides, phosphates, sulphates, titanates, silicates, aluminosilicates having at least one of the elements Zr, Al, Li, particularly preferably zirconium oxide. The inorganic, ion-conducting material preferably comprises particles with a maximum diameter below 100 nm.

Such a separator is sold in Germany under the trade name “Separion” by Evonik AG, for example.

1-14. (canceled)

15. Electrochemical energy store device having electrochemically active components (11, 13; 21, 23; 31, 33) arranged inside a hermetically sealed container without over-pressure valves, predetermined breaking points or rupture discs,
characterized in that
said electrochemically active components (11, 13; 21, 23; 31, 33) or additional components (12; 22; 32) arranged in said container are designed or arranged such that they inhibit the process of at least one chemical reaction of at least part of the electrochemically active components of the energy store device, as soon as positive pressure builds, or could build, inside the container as a result of said chemical reaction.

16. The electrochemical energy store device according to claim 15,
characterized in that
the electrochemically active or other components of said electrochemical energy store device preferably comprise a mobile component, the flow of which into the region of a chemical reaction, in which this mobile component is involved as a reactant, is at least locally inhibited or suppressed as soon as positive pressure builds, or could build, inside the container as a result of said chemical reaction.

17. The electrochemical energy store device according to claim 16,
characterized in that
an at least local change in the temperature, [associated] with overshoot or undershoot of a temperature threshold inside the container, causes the inhibition or suppression of said chemical reaction.

18. The electrochemical energy store device according to claim 17,
characterized in that
the inhibition or suppression of the chemical reaction is at least partially reversible.

19. The electrochemical energy store device according to claim 18,
characterized in that
the inhibition of the chemical reaction is effected by a coating of the electrodes, which is at least locally chemically changed by the chemical reaction.

20. The electrochemical energy store device according to claim 19,
characterized in that
the inhibition of the chemical reaction is effected by an inert or self-inertising coating of the electrodes.

21. The electrochemical energy store device according to claim 20,
characterized in that
the inhibition of the chemical reaction is effected by a separator layer separating the electrodes, which is designed such that a flow of at least one reactant of said chemical reaction along said layer is at least locally inhibited or suppressed, as soon as positive pressure builds, or could build, inside the container as a result of said chemical reaction.

22. The electrochemical energy store device according to claim 21,
characterized in that
a flow of said reactant of the chemical reaction along said separator layer is continuously inhibited or suppressed, because the separator layer comprises channels oriented perpendicular to the layer, in which said reactant can freely move, but wherein the reactant cannot freely move between the channels.

23. The electrochemical energy store device according to claim 22,
characterized in that
the inhibition of the chemical reaction is effected by a separator layer made of a porous inorganic material separating the electrodes.

24. The electrochemical energy store device according to claim 23,
characterized in that
the inhibition of the chemical reaction is effected by a separator layer made of a porous inorganic material separating the electrodes, said material comprising particles which melt on reaching or exceeding a temperature threshold and at least locally shrink or close the pores of the separator layer.

25. The electrochemical energy store device according to claim 24,
characterized in that
the particles of the separator layer consist of a material which is selected from a group of materials comprising polymers or compounds of polymers, waxes and compounds of these materials.

26. The electrochemical energy store device according to any claim 25,
characterized in that
the separator layer is configured such that due to a capillary action, the pores thereof become filled with the mobile component which is involved as a reactant in the chemical reaction, with the result that only a relatively small part of the total amount of the mobile component present in the energy store device is situated outside the pores of the separator layer.

27. The electrochemical energy store device according to claim 26,
characterized in that
said device comprises at least one electrode, preferably at least one cathode, comprising a compound with the formula LiMPO4, wherein M is at least one transition metal cation from the first row of the periodic table of the elements, wherein said transition metal cation is preferably chosen from the group consisting of Mn, Fe, Ni and Ti, or a combination of these elements, and wherein said compound preferably has an olivine structure, preferably higher-order olivine, wherein Fe is particularly preferred.

28. The electrochemical energy store device according to claim 27,
characterized in that
said device comprises at least one electrode, preferably at least one cathode, which comprises a lithium manganate, preferably LiMn204 of the spinell type, a lithium cobaltate, preferably LiCo02, or a lithium nickelate, preferably LiNi02, or a mixture of two or three of these oxides, or a lithium compound oxide which contains manganese, cobalt and nickel.

29. The electrochemical energy store device according to claim 28,
characterized in that
said device comprises at least one separator, which does not conduct electrons or does so only weakly, and which consists of an at least partially material-permeable substrate, wherein said substrate is preferably coated on at least one side with an inorganic material, wherein an organic material, preferably implemented as a non-woven fabric, is preferably used as an at least partially material-permeable substrate, wherein said organic material preferably comprises a polymer and particularly preferably a polyethylene terephthalate (PET), wherein said organic material is coated with an inorganic, preferably ion-conducting material which is further preferably ion-conducting in a temperature range of −40° C. to 200° C., wherein said inorganic material preferably comprises at least one compound from the group of oxides, phosphates, sulphates, titanates, silicates, aluminosilicates of at least one of the elements Zr, Al, Li, particularly preferably zirconium oxide, and wherein said inorganic, ion-conducting material preferably comprises particles having a maximum diameter of less than 100 nm.

30. A method for producing an electrochemical energy store device having components (11, 13; 21, 23; 31, 33) arranged inside a hermetically sealed container without over-pressure valves, predetermined breaking points or rupture discs,
characterized in that
said electrochemically active components (11, 13; 21, 23; 31, 33) or additional components (12; 22; 32) arranged in said container, are designed or arranged such that they inhibit the process of at least one chemical reaction of at least a part of the electrochemically active components of said energy store device, as soon as positive pressure builds, or could build, inside the container as a result of said chemical reaction.
